(19) United States
(12) Patent Application Publication
(10) Pub. No.: US 2013/0239173 A1
(43) Pub. Date: Sep. 12, 2013

(54) COMPUTER PROGRAM AND METHOD FOR ADMINISTERING SECURE TRANSACTIONS USING SECONDARY AUTHENTICATION

(71) Applicant: Stephen T. Dispensa, Leawood, KS (US)

(72) Inventor: Stephen T. Dispensa, Leawood, KS (US)

(21) Appl. No.: 13/418,043

(22) Filed: Mar. 12, 2012

(51) Int. Cl. G06F 21/00

(52) U.S. Cl. 726/2

(57) ABSTRACT

Administering secure transactions using secondary authentication includes receiving a transaction request from a user using a first client device, determining whether the requested transaction is a type of transaction that is already approved, determining whether one or more current parameters of the transaction are within limits that are already established if the type of transaction is already approved, transmitting a secondary authentication request to the user to approve the transaction if the current parameters are outside of already established limits or if the type of transaction is not already approved, receiving a response to the secondary authentication request from the user, determining from the response whether the user approved the transaction, aborting the transaction if the user denies the transaction, and performing the transaction if the user approves the transaction or if the type of transaction is already approved and the current parameters are within already established limits.

### BACKGROUND

1. Field

Embodiments of the present invention relate to computer programs and methods for administering secure transactions using a system with secondary authentication.

2. Related Art

Access to secure data resources at a secure data resource institution, such as a bank or a medical records facility, may require two levels of authentication. A primary authentication usually occurs when a user requests access to the secure data resources. The user may submit a username and password over a secure link. If the username and password match the username and password combination that is stored at the secure data resource institution, then the user is authenticated and may have access to the secure data resources. Some institutions may implement a second level of authentication. One form of secondary authentication occurs when the institution contacts the user through a second channel, often by a phone call, to verify that the actual user, and not an imposter, made the request for access to secure data resources. The user may enter a code or select the hash or pound key on the phone to supply the verification.

Some institutions may also require secondary authentication for verification of transaction requests. For example, for every transaction that user requests, such as withdrawal of funds, access to records, or the like, the institution may perform a secondary authentication and contact the user with a phone call. While this approach may provide security, it may also be inconvenient for the user, especially if the user has a large number of transactions to request or requests transactions on a regular basis.

A user, such as an administrator or a manager, may also wish to enroll other users to have access to the secure data resources. The enrollment of a user may involve submitting a username and a contact identifier, such as a phone number. The institution may utilize a secondary authentication and contact the administrator with a phone call. For each new user that the administrator wishes to enroll, the administrator may have to enter an approval code into the phone. As mentioned above, this approach may be inconvenient and time consuming for the administrator.

### SUMMARY

Embodiments of the present invention solve the above-mentioned problems and provide computer programs and methods for administering secure transactions using a system with secondary authentication.

A first embodiment of the present invention includes a non-transitory computer-readable storage medium with an executable program stored thereon for administering secure transactions using secondary authentication. The program comprises instructions to perform the following steps: receiving a transaction request from a user using a first client device, determining whether the requested transaction is a type of transaction that is already approved, determining whether one or more current parameters of the transaction are within limits that are already established if the type of transaction is already approved, transmitting a secondary authentication request to the user to approve the transaction if the current parameters are outside of already established limits or if the type of transaction is not already approved, receiving a response to the secondary authentication request from the user, determining from the response whether the user approved the transaction, aborting the transaction if the user denies the transaction, and performing the transaction if the user approves the transaction or if the type of transaction is already approved and the current parameters are within already established limits. The first embodiment is particularly advantageous for use with batch transactions comprising numerous transactions, but, as should be appreciated, may be used for a single transaction or a small number of transactions.

A second embodiment of the present invention includes a non-transitory computer-readable storage medium with an executable program stored thereon for automatically enrolling users for access to secure data resources. The program comprises instructions to perform the following steps: receiving a user enrollment request from a requester, preparing a verification request that includes a plurality of usernames and a plurality of contact identifiers, each username corresponding to a user and associated with one contact identifier, transmitting the verification request to a third party server device, receiving verification results from the third party server device, and enrolling users whose username and contact identifier were verified by the third party server device.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic depiction of a system for administering secure transactions using secondary authentication and for automatically enrolling users for access to secure data resources, constructed in accordance with various embodiments of the present invention;

FIG. 2 is a depiction of a first client device;

FIG. 3 is a depiction of a second client device;

FIG. 4 is a depiction of a third client device;

FIG. 5 is a flow chart of a method of administering secure transactions using secondary authentication; and

FIG. 6 is a flow chart of a method of automatically enrolling new users to access secure data resources.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system 10 for administering secure transactions using secondary authentication. The transactions may include, but are not limited to, financial transactions, such as a deposit or a transfer of funds, or secure information access, such as modifying or sharing medical records, personal information, or classified information. The request for the transactions may be made through a first communications channel. The secondary authentication may include contacting the user through a second communications channel, different from the first communications channel, to verify the transactions.

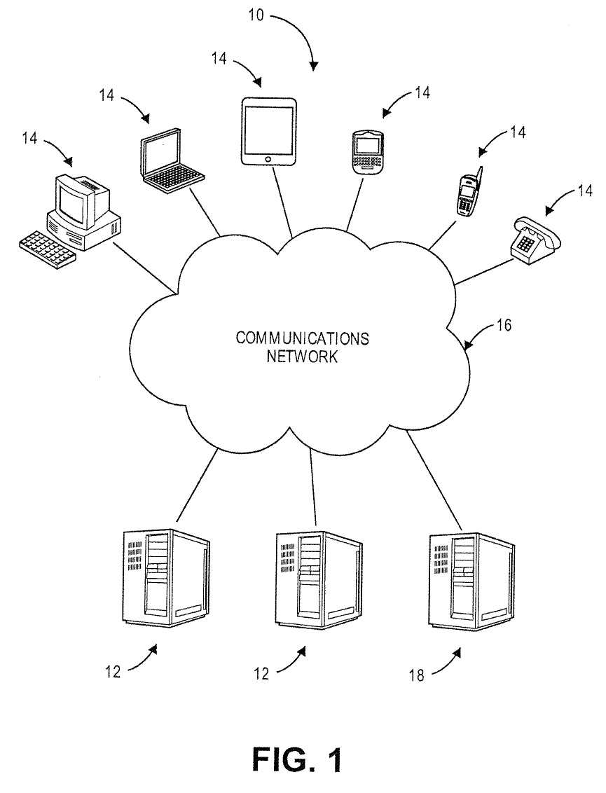

The computer program and the method may be implemented in hardware, software, firmware, or combinations thereof using the system 10, shown in FIG. 1, which broadly comprises server devices 12, client devices 14, and a communications network 16. The server devices 12 may include computing devices that provide access to one or more general computing resources such as internet services, electronic mail services, data transfer services, and the like. The server devices 12 may also provide access to secured or restricted resources such as financial accounts, medical records, personal information databases, intellectual property storage, and the like.

The computing device may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 12 may further include file stores comprising a plurality of hard disk drives, network attached storage, or a separate storage network.

The client devices 14 may include computing devices as described above. Examples of the client device 14 may include work stations, desktop computers, laptop computers, palmtop computers, tablet computers, portable digital assistants (PDA), smart phones, and the like, or combinations thereof. Various embodiments of the client device 14 may also include voice communication devices such as cell phones or landline phones.

The communications network 16 may be wired or wireless and may include servers, routers, switches, wireless receivers and transmitters, and the like, as well as electrically conductive cables or optical cables. The communications network 16 may also include local, metro, or wide area networks, as well as the Internet, or other cloud networks. Furthermore, the communications network 16 may include cellular or mobile phone networks, as well as landline phone networks or public switched telephone networks.

Both the server devices 12 and the client devices 14 may be connected to the communications network 16. Server devices 12 may be able to communicate with other server devices 12 or client devices 14 through the communications network 16. Likewise, client devices 14 may be able to communicate with other client devices 14 or server devices 12 through the communications network 16. The connection to the communications network 16 may be wired or wireless. Thus, the server devices 12 and the client devices 14 may include the appropriate components to establish a wired or a wireless connection.

The computer program may run on one or more server devices 12. Thus, a first portion of the program, code, or instructions may execute on a first server device 12, while a second portion of the program, code, or instructions may execute on a second server device 12. In some embodiments, other portions of the program, code, or instructions may execute on other server devices 12 as well. For example, a first portion of the program, code, or instructions may execute on a financial institution server device 12, and a second portion of the program, code, or instructions may execute on a server device 12 that handles a secondary authentication request, as discussed in more detail below.

### Transaction Authentication Without Secondary Authentication

Embodiments of the present invention may be used to administer transactions with secondary authentication as follows. A preliminary system setup may be performed before a current user requests a transaction. The setup may be performed by a system administrator working for the institution that manages the secure data resources, a superuser with administrative privileges who works for the same entity as the current user, or the current user himself before he requests a transaction. The setup may include identifying the types of transactions that can be performed without secondary authentication. The setup may further include identifying limits for each type of transaction, wherein transactions within the limits do not require secondary authentication. For example, for a financial institution, deposits, withdrawals, and transfers of funds may be allowed without secondary authentication for certain accounts; may be allowed without secondary authentication for certain accounts and within certain dollar amounts; and/or may only be allowed without secondary authentication if the transaction is within a certain dollar amount, regardless of the type of transaction. But, secondary authentication may be required for other accounts and/or dollar amounts that exceed the limit. For a data or records repository, accessing, modifying, or sharing data in a record without secondary authentication may be allowed for certain types of data, between or among certain parties or types of parties, and/or for certain records. For access to other types of data or other records, secondary authentication may be required. Thus, as can be appreciated, the “type of transaction” and the “limit” relative to the account may vary depending on the nature of the account (e.g., bank account vs. medical records account), the expected risk associated with the account, the level of security desired by the account holder and/or the account administrator, and/or other suitable factors. If the type of transaction does not require secondary authentication, it is a pre-approved transaction.

After the setup is complete, the current user may wish to perform a transaction involving secure data resources. The transaction may be a single-step transaction or may include a plurality of steps to be performed. For example, the user may wish to transfer funds between two or more accounts or may wish to deposit funds into a plurality of accounts. As another example, the user may wish to modify the data in one or more secure access files or may wish to transfer the files from one location to one or more other locations.

The user may initiate a transaction by first gaining access to a server device 12. Typically, the server device 12 is a secure server device 12 that supports any of the major security protocols, such as SSL, that encrypt and decrypt messages to protect them against third-party tampering. The user may send a login request from a client device 14 through the communications network 16 and to the server device 12. The request may be sent from a first client device 14 such as a desktop, laptop, or tablet computer, as well as a smartphone, PDA, or similar device. In addition, the request may be sent through a first communications channel. The login request may include a username and password combination and may be processed in a manner that is known in the art. In various embodiments, the login request may be processed as disclosed in U.S. patent application Ser. No. 12/394,016, “ENHANCED MULTI FACTOR AUTHENTICATION”, filed Feb. 26, 2009, which is hereby incorporated by reference, in its entirety.

The first communications channel may include the parameters that are used to establish the communication between the client device 14 and the server device 12. These parameters may include, but are not limited to, the software application used on the client device 14 to initiate the communication, such as a web browser, the type of encryption used for the communication between the client device 14 and the server device 12, the type of communication established, such as data vs. voice, etc. A change to any one or more of these parameters creates a different channel.

Examples of different channels of communication may include a first communications channel being established from a first client device 14 transmitting data to the server device 12. A second communications channel may be established from the server device 12 transmitting voice to a second client device 14, such as a smart, cell, or landline phone. This example of two-channel communication may also be set up using the same client device 14. Thus, a user may use a smartphone as the client device 14 to establish a first communications channel using a web browser transmitting data to the server device 12. A second communications channel may be established with the server device 12 transmitting voice to the same smartphone. As a second example, first and second channels of communication may be established between the client device 14 and the server device 12 using first and second types of encryption. As a third example, the user may establish a first communications channel by executing a first application, such as a web browser, on a first client device 14 to contact the server device 12. The user may establish a second communications channel by executing a second application, on the first client device 14 or a second client device 14, that receives authentication messages from the server device 12.

Once the user has successfully logged in to the server device 12, the user may initiate a transaction request. As with the login request, the transaction request may be sent from the client device 14 through the first communications channel to the server device 12. If the requested transaction is of a type that is already approved and/or the parameters of the requested transaction are within the approved limits, then the server device 12 may perform the requested transaction without seeking secondary authentication from the user. As an example, the user may request to deposit funds into one hundred different accounts. If the dollar amounts are within the pre-defined or pre-established limits and the accounts have been approved for access, then the user will not be contacted for secondary authentication. As noted above, the requested transaction could also be approved without secondary authentication based on only the type of transaction and without reference to the pre-established limit associated with the transaction. Additionally, reference is being made herein to a pre-established limit. As can be appreciated, instead of evaluating a “limit” associated with the transaction, embodiments of the present invention could instead evaluate a minimum associated with the transaction. In this case, if the dollar amounts for the transaction are above a pre-established minimum, then the transaction may require secondary authentication.

If the user requests a transaction that has not been approved or the parameters of the transaction are outside of the limits, then a secondary authentication request may be sent to a contact identifier associated with the user. The contact identifier may be stored on the server device 12, or stored on a device accessible to the server device 12, when the user's account is set up. The contact identifier generally provides an alternative way to contact the user and may include a telephone number for the user's smart, cell, or landline phone, an address associated with a user's client device 14, such as an Internet Protocol (IP) address or a media access code (MAC) address, and the like, or combinations thereof.

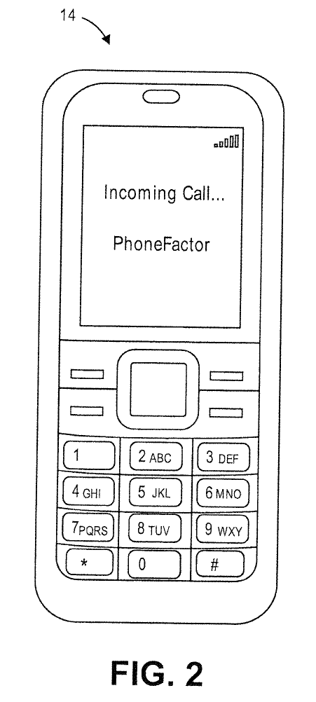

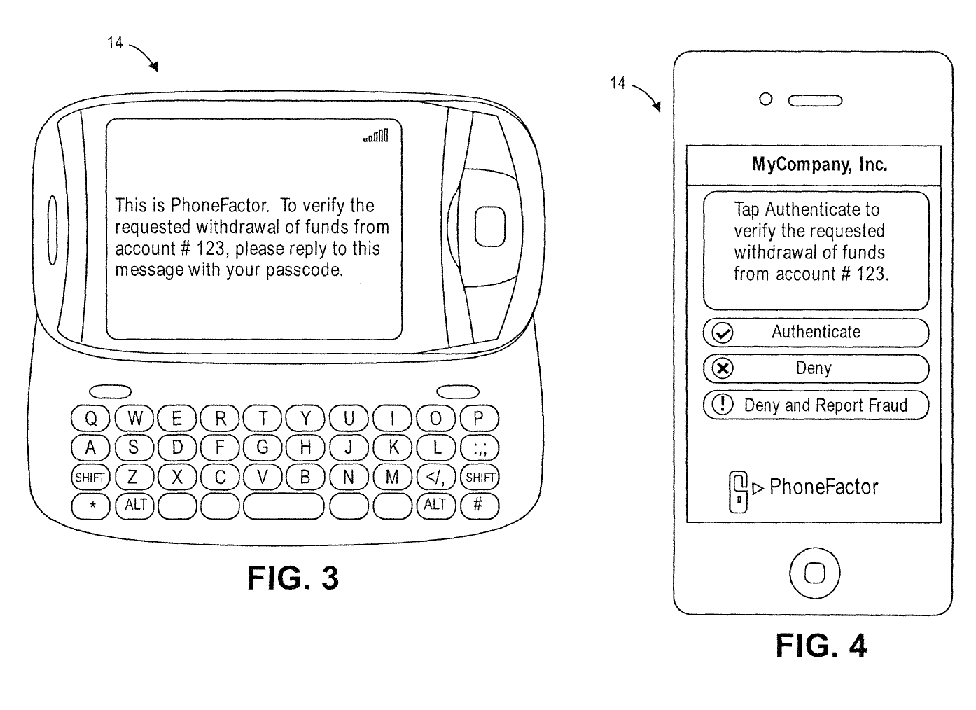

Examples of the secondary authentication request may include a verbal description of the transaction by the server device 12 using voice synthesis, pre- recorded messages, or a combination of the two sent to the user's client device 14 that includes a smart, cell, or landline phone, seen in FIG. 2, a text message, such as a short message service (SMS) text, describing the transaction sent to the user's client device 14 that includes a tablet, a smart or cell phone, seen in FIG. 3, a notification describing the transaction sent to a client device 14 that is running a software application programmed to receive notifications from the server device 12, seen in FIG. 4, and the like. The secondary authentication request is sent through a second communications channel and may be received by the user on the first client device 14 (that initiated the transaction request) or a second client device 14.

If the user approves of the transaction request, he may transmit an approval back to the server device 12. The nature of the approval may depend on how the secondary authentication request was transmitted and the client device 14 that receives the secondary authentication request. If the secondary authentication request was sent as a voice message to the client device 14 such as a phone, then the user may reply by entering a first code, which may include one or more entries on the phone keypad of numbers (0-9), symbols (*,#), or combinations of both. In various embodiments, the user may also give verbal approval, such as by saying the word “Yes”. If the secondary authentication request was sent as a text message to the client device 14, then the user may reply by sending a text message back that includes the first code. In some embodiments, the user may reply with a text message that includes a second code, such as a codeword like the name of the user's birthplace or a similar security word. If the secondary authentication request was sent as a notification to a software application on the user's client device 14, then the user may reply by selecting a “Yes” or “Approve” indicator that is part of the software application.

If the user made a mistake in the transaction request or did not initiate the transaction request, then he may transmit a denial back to the server device 12. As with the approval, the nature of the denial may depend on how the secondary authentication request was transmitted and the client device 14 that receives the secondary authentication request. If the secondary authentication request was sent as a voice message to the client device 14 such as a phone, then the user may reply by entering anything but the first code, or the user may enter a specific denial code. In various embodiments, the user may also give verbal denial, such as by saying the word “No”. If the secondary authentication request was sent as a text message to the client device 14, then the user may reply by sending a text message back that includes anything but the first code or the second code. Alternatively, the user may text the denial code. If the secondary authentication request was sent as a notification to a software application on the user's client device 14, then the user may reply by selecting a “No” or “Deny” indicator that is part of the software application.

If the user approves the transaction by the secondary authentication, then the server device 12 may perform the transaction. If the user does not approve the transaction, then the server device 12 may abort the transaction and it may alert the authorities that illegal activities were just attempted if the user did not initiate the transaction request.

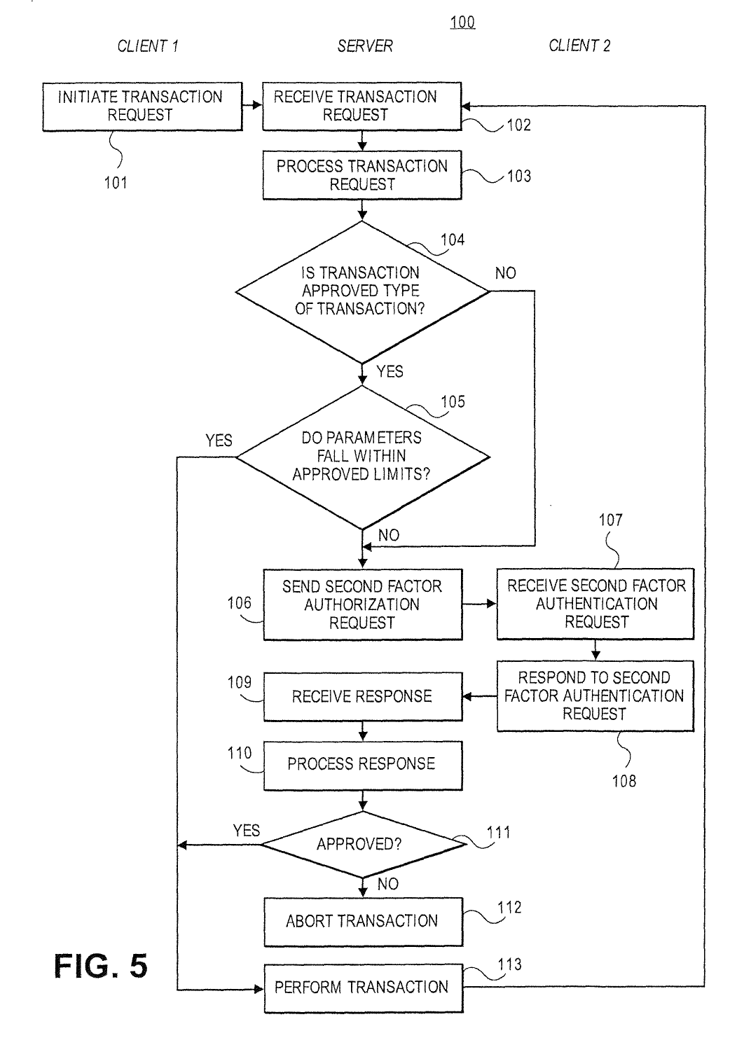

A method 100 for administering periodic transactions using secondary authentication in accordance with various embodiments of the present invention is illustrated in FIG. 5. The steps of the method may be performed in the order shown in FIG. 5, or they may be performed in a different order. Furthermore, some steps may be performed concurrently as opposed to sequentially. Also, some steps may be optional. In general, when referring to FIG. 5, steps listed in the left column may be performed by a first client device 14, steps listed in the center column may be performed by a server device 12, and steps listed in the right column may be performed by a second client device 14. In addition, some of the steps listed may be part of the computer program of the present invention.

In step 101, a transaction request is initiated. A user, who already has access to secured data resources, issues the transaction request from a first client device 14 on a first communications channel through the communications network 16 to a secure server device 12.

In step 102, the transaction request is received by the server device 12. In step 103, the transaction request is processed by the server device 12. The server device 12 may parse the request to determine the nature of the transaction and the parameters. For a financial institution application, the server device 12 may determine whether the transaction is a deposit, a withdrawal, a transfer of funds, etc., and which accounts are involved. For other applications, the server device 12 may determine whether information is being access, modified, or transferred, along with the type of information, which records, and who is the recipient in the case of a transferral.

In step 104, the server device 12 determines whether the type of transaction has already been approved. If the transaction type has been approved, then the method proceeds to step 105. If the transaction type has not been approved, then the method proceeds to step 106. In alternative embodiments, step 104 may include a substep (not shown) that analyzes the type of transaction and determines if it is a type that is automatically approved, such that the computer program and method immediately performs the transaction of step 113. If it is not a type that is automatically approved, then the computer program and method determine if it is the type that is approved if the parameters fall within the approved or pre-established limits, as illustrated in step 105.

In step 105, the server device 12 determines whether the parameters of the requested transaction fall within the approved limits. If the transaction parameters are within limits, then the method proceeds to step 113. If the transaction parameters exceed the limits, then the method proceeds to step 106.

In step 106, a secondary authentication request is transmitted by the server device 12 through the communications network 16 on a second communications channel to the client device 14 using the client identifier associated with the current user. Depending on the client identifier, the secondary authentication request may include an oral description of the transaction by the server device 12, a text message describing the transaction, a notification describing the transaction, or similar actions.

In step 107, the secondary authentication request is received by the user on the client device 14. In step 108, a response to the secondary authentication request is generated. The user either approves the transaction or denies it. If the user approves the transaction, then he may enter a first code or verbal approval if the client device 14 is a phone, a second code or the first code if the secondary authentication request is a text message, or a selection of an authenticate indicator if the secondary authentication request is a notification to a software application on the user's client device 14. If the user denies the transaction request, then he may give a verbal denial or enter anything other than the first code if the client device 14 is a phone, enter anything but the first code or the second code if the secondary authentication request is a text message, or select a deny indicator if the secondary authentication request is a notification to a software application on the user's client device 14. The response may be transmitted back to the server device 12.

In step 109, the response to the secondary authentication request from the user is received by the server device 12. In step 110, the response is processed. In step 111, the server device 12 determines whether the user responded with an approval or a denial. If the user approved, then the method proceeds to step 113. If the user denied the transaction, then the method proceeds to step 112.

In step 112, the server device 12 aborts the transaction requested by the user. The server device 12 may also send a message to the client device 14 that initiated the transaction request that the transaction has been aborted as a result of a denial from the secondary authentication request. In some embodiments, the server device 12 may issue an alert to authorities or system administrators that a transaction was just denied. Afterwards, the method may proceed back to step 102 to wait for another request.

In step 113, the transaction is performed by the server device 12. The server device 12 may also send a message to the client device 14 that initiated the transaction request that the transaction has been successfully completed.

### User Enrollment

Other embodiments of the present invention provide a computer program and method for performing automated user enrollment to access secure data resources using secondary authentication. The computer program and method may utilize the system 10 described above.

Enrollment of a plurality of users that can access secure data resources typically requires that a first user, such as a superuser or a system administrator, submit a user's name, or username, along with a contact identifier for each new user to be enrolled. The contact identifier is the information, such as a phone number, that will be used to contact the new user for secondary authentication once the new user requests access to secure data resources. The request for enrollment of users is usually transmitted by the first user from a client device 14 on a first communications channel through the communications network 16 to a server device 12. After the server device 12 processes the request, the server device 12 may transmit a secondary authentication request to the first user through a second communications channel, as described above. The first user may then have to approve the username and contact identifier combination for each new user.

The approval process may involve the server device 12 transmitting the username and associated contact identifier to the first user and then receiving an approval code entered by the first user on the client device 14, if the combination of the username and contact identifier is correct. If the combination of the username and contact identifier is not correct, then the first user may enter a denial code. This process is repeated for every new user to be enrolled. For even a small number of new users, this process can be time consuming and tedious. For a large number of new users, the process may take hours.

Enrollment of a plurality of users may be automated using embodiments of the present invention. The first user may submit a list of users to be enrolled along with an enrollment request from the client device 14 to the server device 12, as described above. Instead of the server device 12 contacting the first user to approve the combination of the username and contact identifier for each new user, the server device 12 may contact a third party to verify the contact identifier. The third party may be any office, agency, or service, such as a credit bureau or a phone company, that can verify the contact identifier associated with the username. Credit bureaus often possess databases with a variety of contact information, such as addresses and phone numbers, for a given individual. Phone companies possess databases of phone numbers along with the associated owner's name.

The server device 12 may send the verification request to a third party server device 18, which may be substantially similar to the server device 12. The verification request may include a plurality of username and contact identifier combinations. The third party server device 18 may receive the request and parse the request into a list of usernames. For each username, the third party server device 18 may search one or more databases for the username. If the username is not found, then the third party server device 18 may send a username not found message, or the like, back to the server device 12. If the username is found, but the contact identifier does not match any of the contact information stored in the database, then the third party server device 18 may send a contact identifier not verified message back to the server device 12. If the username is found and the contact identifier matches contact information in the database, then the third party server device 18 may send a contact identifier verified message back to the server device 12. For each username, the third party server device 18 may perform the same search and return the results of the search to the server device 12.

Alternatively, the third party server device 18 may search databases for the contact identifier, such as a phone number, and then analyze the username associated with the contact identifier. Based on the results, the third party server device 18 may report that the username and the contact identifier match, the contact identifier was found but did not match the username, or the contact identifier was not found. In even further alternatives, the third party server device 18 may search databases for any known and valid information for a particular user, such as the user's social security number, the user's address, etc.

Having received the verification results, the server device 12 may enroll those users whose username and associated contact identifier were verified by the third party. In some embodiments, the server device 12 may send a second verification request to other third party server devices 18 for any usernames that were either not found or the contact identifier was not verified from the first verification request. After all of the verification results have been received and the verified users have been enrolled, the server device 12 may send a report to the first user that identifies which users were enrolled and which users were not enrolled and, optionally, why the user was not enrolled, such as the username not being found or the contact identifier not being verified. The first user may choose to manually enroll the users who were not enrolled automatically.

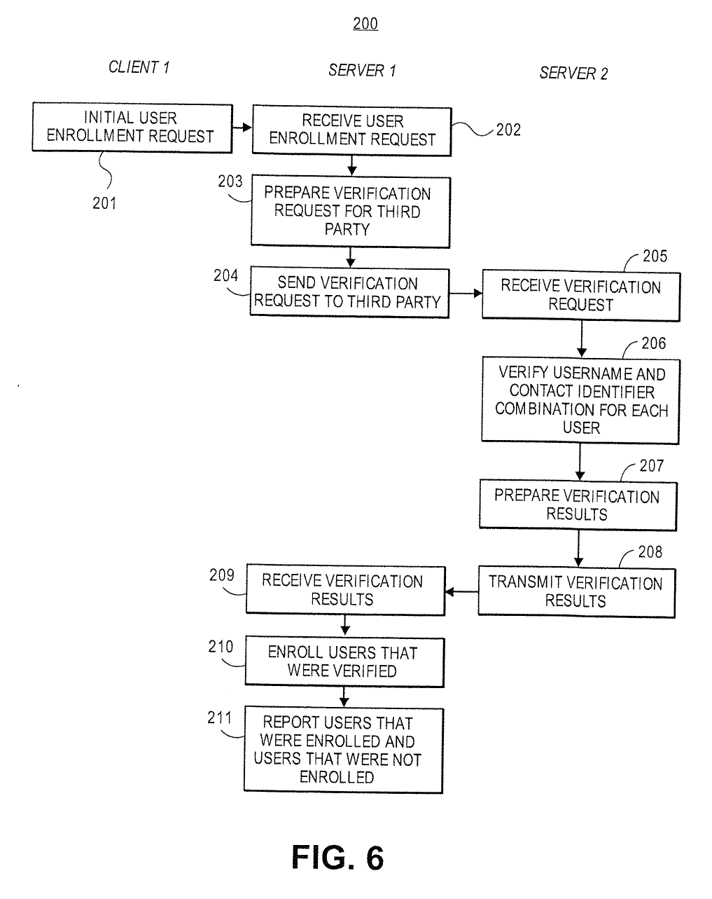

A method 200 for automatically enrolling users for access to secure data resources in accordance with various embodiments of the present invention is illustrated in FIG. 6. The steps of the method may be performed in the order shown in FIG. 6, or they may be performed in a different order. Furthermore, some steps may be performed concurrently as opposed to sequentially. Also, some steps may be optional. In general, when referring to FIG. 6, steps listed in the left column may be performed by a first client device 14, steps listed in the center column may be performed by a server device 12, and steps listed in the right column may be performed by a second client device 14. In addition, some of the steps listed may be part of the computer program of the present invention.

In step 201, a user enrollment request is initiated. A first user, who already has access to secured data resources, issues the user enrollment request from a first client device 14 on a first communications channel through the communications network 16 to a secure server device 12.

In step 202, the user enrollment request is received by the server device 12. In step 203, the user enrollment request is processed by the server device 12. The server device 12 may parse the request in order to prepare a verification request for a third party server device 18. The verification request may include a plurality of usernames and associated contact identifiers. In step 204, the server device 12 sends the verification request to a third party server device 18.

In step 205, the third party server device 18 receives the verification request. In step 206, the verification request is processed. For each username, the third party server device 18 may search one or more databases for the username and then verify that associated contact identifier matches the contact identifier in the database for the username. For example, if the contact identifier includes a telephone number, the third party server device 18 may search the databases for the username and then verify that the phone number in the verification request matches the phone number in the databases for the username. The third party server device 18 may record whether, for each username, the contact identifier in the verification request matched the contact identifier in the databases. In step 207, the third party server device 18 prepares the results of the verification process. For example, for each username and contact identifier, the third party server device 18 may indicate a match or a failure. In step 208, the third party server device 18 transmits the verification results to the server device 12.

In step 209, the verification results are received by the server device 12. In step 210, the verification results are processed by the server device 12. For all the usernames that were verified as a match by the third party server device 18, the server device 12 may enroll the associated user. The server device 12 does not enroll those users whose usernames were indicated as a failure by the third party server device 18. In step 211, the server device 12 prepares a report for the first user that indicates for each username whether the user was enrolled or not. The first user may also have the option of manually approving enrollment for those users who were not enrolled by the automatic process.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium with an executable program stored thereon for administering secure transactions using secondary authentication, wherein the program instructs a processor to perform the following steps:
receiving a transaction request from a user using a first client device;
determining whether the requested transaction is a type of transaction that is already approved;
determining whether one or more current parameters of the transaction are within limits that are already established if the type of transaction is already approved;
transmitting a secondary authentication request to the user to approve the transaction if the current parameters are outside of already established limits or if the type of transaction is not already approved;
receiving a response to the secondary authentication request from the user;
determining from the response whether the user approved the transaction;
aborting the transaction if the user denies the transaction; and
performing the transaction if the user approves the transaction or if the type of transaction is already approved and the current parameters are within already established limits.

2. The computer-readable storage medium of claim 1, wherein the transaction request is received on a first communications channel and the secondary authorization request is transmitted on a second communications channel, different from the first communications channel.

3. The computer-readable storage medium of claim 2, wherein the first communications channel utilizes a first type of data encryption and the second communications channel utilizes a second type of data encryption.

4. The computer-readable storage medium of claim 2, wherein the first communications channel carries data transmissions and the second communications channel carries voice transmissions.

5. The computer-readable storage medium of claim 2, wherein the first communications channel includes a first communications software application executing on the first client device and the second communications channel includes a second communication software application executing on the first client device.

6. The computer-readable storage medium of claim 1, wherein the secondary authorization request is transmitted so that the user receives the request on a second client device.

7. The computer-readable storage medium of claim 1, wherein the secondary authorization request includes a verbal description of the requested transaction.

8. The computer-readable storage medium of claim 1, wherein the secondary authorization request includes a short message service text description of the requested transaction.

9. The computer-readable storage medium of claim 1, wherein the secondary authorization request includes a phone call transmitted to a phone of the user.

10. A method of administering secure transactions using secondary authentication, the method comprising the steps of:
receiving, with a server device, a transaction request from a user using a first client device;
determining whether the requested transaction is a type of transaction that is already approved;
determining whether one or more current parameters of the transaction are within limits that are already established if the type of transaction is already approved;
transmitting a secondary authentication request to the user to approve the transaction if the current parameters are outside of already established limits or if the type of transaction is not already approved;
receiving a response to the secondary authentication request from the user;
determining from the response whether the user approved the transaction;
aborting the transaction if the user denies the transaction; and
performing the transaction if the user approves the transaction or if the type of transaction is already approved and the current parameters are within already established limits.

11. The method of claim 10, wherein the transaction request is received on a first communications channel and the secondary authorization request is transmitted on a second communications channel, different from the first communications channel.

12. The method of claim 11, wherein the first communications channel utilizes a first type of data encryption and the second communications channel utilizes a second type of data encryption.

13. The method of claim 11, wherein the first communications channel carries data transmissions and the second communications channel carries voice transmissions.

14. The method of claim 11, wherein the first communications channel includes a first communications software application executing on the first client device and the second communications channel includes a second communications software application executing on the first client device.

15. The method of claim 10, wherein the secondary authorization request is transmitted so that the user receives the request on a second client device.

16. The method of claim 10, wherein the secondary authorization request includes a verbal description of the requested transaction.

17. The method of claim 10, wherein the secondary authorization request includes a short message service text description of the requested transaction.

18. The method of claim 10, wherein the secondary authorization request includes a phone call transmitted to a phone of the user.

19. A non-transitory computer-readable storage medium with an executable program stored thereon for automatically enrolling users for access to secure data resources, wherein the program instructs a processor to perform the following steps:
receiving a user enrollment request from a requester;
preparing a verification request that includes a plurality of usernames and a plurality of contact identifiers, each username corresponding to a user and associated with one contact identifier;
transmitting the verification request to a third party server device;
receiving verification results from the third party server device; and
enrolling users whose username and contact identifier were verified by the third party server device.

20. The computer-readable storage medium of claim 19, further including the step of not enrolling users whose username and contact identifier were not verified by the third party server device.

21. The computer-readable storage medium of claim 20, further including the step of reporting to the requester the users who were enrolled and the users that were not enrolled.

22. The computer-readable storage medium of claim 19, wherein the contact identifier includes a telephone number.
